(19) United States
(12) Patent Application Publication
(10) Pub. No.: US 2024/0006599 A1
(43) Pub. Date: Jan. 4, 2024

(54) SECONDARY BATTERY

(71) Applicant: SEMICONDUCTOR ENERGY LABORATORY CO., LTD., Atsugi-shi (JP)

(72) Inventors: Kenji ARAI, Isehara (JP); Taisuke NAKAO, Atsugi (JP)

(21) Appl. No.: 18/342,457

(22) Filed: Jun. 27, 2023

(30) Foreign Application Priority Data
Jun. 29, 2022 (JP) 2022-104610

(51) Int. Cl. H01M 4/38; H01M 4/62; H01M 10/0569; H01M 4/134

(52) U.S. Cl. CPC H01M 4/386; H01M 4/622; H01M 10/0569; H01M 4/134; H01M 2300/0028; H01M 2004/027

(57) ABSTRACT

A novel secondary battery that is highly convenient, useful, or reliable can be provided. The secondary battery includes a positive electrode active material layer, a negative electrode active material layer, and a separator. The separator is interposed between the positive electrode active material layer and the negative electrode active material layer. The negative electrode active material layer includes silicon particles and a binder. The weight ratio of the binder to the silicon particles is greater than or equal to 0.05 and less than or equal to 10. The binder has a carboxy group. The bulk specific gravity of the silicon particles is greater than or equal to 0.02 g/cm³ and less than or equal to 0.5 g/cm³.

### BACKGROUND OF THE INVENTION

### 1. Field of the Invention

One embodiment of the present invention relates to a secondary battery or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

In order to increase the capacities of lithium-ion secondary batteries and improve their charge-discharge cycle performance, various researches and developments have been conducted on both positive and negative electrodes. As for negative electrode active materials, it is known that silicon-based materials have higher capacities than graphite-based materials, and negative electrodes using silicon-based materials have been examined (e.g., Patent Documents 1 and 2).

### REFERENCE

[Patent Document 1] Japanese Published Patent Application No. 2010-113870
[Patent Document 2] Japanese Published Patent Application No. 2019-165005

### SUMMARY OF THE INVENTION

An object of one embodiment of the present invention is to provide a secondary battery that is highly convenient, useful, or reliable. Another object is to provide a novel secondary battery or a novel semiconductor device.

Note that the description of these objects does not preclude the existence of other objects. In one embodiment of the present invention, there is no need to achieve all these objects. Other objects will be apparent from and can be derived from the description of the specification, the drawings, the claims, and the like.

(1) One embodiment of the present invention is a secondary battery including a positive electrode active material layer, a negative electrode active material layer, and a separator.

The separator is interposed between the positive electrode active material layer and the negative electrode active material layer. The negative electrode active material layer includes a silicon particle and a binder. The weight ratio of the binder to the silicon particle is greater than or equal to 0.05 and less than or equal to 10.

The binder has a carboxy group. The bulk specific gravity of the silicon particle is greater than or equal to 0.02 g/cm³ and less than or equal to 0.5 g/cm³.

(2) One embodiment of the present invention is the above-described secondary battery including an electrolyte solution. The electrolyte solution is interposed between the positive electrode active material layer and the negative electrode active material layer. The electrolyte solution contains an ionic liquid.

(3) One embodiment of the present invention is the above-described secondary battery, in which the electrolyte solution contains lithium bis(fluorosulfonyl)imide (abbreviation: LiFSI) and 1-ethyl-3-methylimidazolium bis(fluorosulfonyl)imide (abbreviation: EMI-FSI).

Thus, the silicon particles can be bound to each other with the use of the binder. In addition, at least part of the surfaces of the silicon particles can be covered and protected with the binder. The binder has a carboxy group, and an oxygen atom of the carboxy group has an unshared electron pair. In the electrolyte solution, lithium ions are stabilized by solvation. The existence of the unshared electron pair near the silicon particles can contribute to the stability of the lithium ions. Furthermore, the silicon particles can be protected from a side reaction at the time of charging and discharging of the secondary battery. Moreover, a reaction caused between the ionic liquid and the silicon particles can be inhibited. As a result, a novel secondary battery that is highly convenient, useful, or reliable can be provided.

(4) One embodiment of the present invention is the above-described secondary battery, in which the binder contains polyglutamic acid.

(5) One embodiment of the present invention is the above-described secondary battery, in which the binder contains poly(acrylic acid).

Thus, with the use of the binder, silicon particles can be dispersed into the slurry with stability. Furthermore, the viscosity of the slurry can be adjusted. As a result, a novel secondary battery that is highly convenient, useful, or reliable can be provided.

(6) One embodiment of the present invention is the above-described secondary battery, in which the negative electrode active material layer contains graphite and the weight ratio of the graphite to the silicon particle is greater than 0 and less than or equal to 19.

Thus, metal ions can be occluded or released by/from not only the silicon particles but also the graphite particles. Furthermore, the graphite particles can be bound with each other using the binder. In addition, at least part of the surface of the graphite can be covered and protected with the binder. Moreover, the graphite can be protected from a side reaction at the time of charging and discharging of the secondary battery. In addition, a reaction caused between the ionic liquid and the graphite can be inhibited. As a result, a novel secondary battery that is highly convenient, useful, or reliable can be provided.

Although the block diagram in drawings attached to this specification shows components classified based on their functions in independent blocks, it is difficult to classify actual components based on their functions completely, and one component can have a plurality of functions.

According to one embodiment of the present invention, a novel secondary battery that is highly convenient, useful, or reliable can be provided. Furthermore, a novel secondary battery can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A to 1C illustrate the structure of a secondary battery of an embodiment;

FIGS. 2A to 2C illustrate the structure of a coin-type secondary battery of an embodiment;

FIGS. 3A to 3D illustrate cylindrical secondary batteries of an embodiment;

FIGS. 4A to 4C illustrate a secondary battery of an embodiment;

FIGS. 5A and 5B each illustrate a secondary battery of an embodiment;

FIGS. 6A to 6C illustrate a method for fabricating a secondary battery of an embodiment;

FIGS. 7A to 7D illustrate transport vehicles each equipped with a secondary battery of an embodiment;

FIGS. 8A and 8B illustrate a building provided with a secondary battery of an embodiment;

FIGS. 9A to 9C illustrate a bicycle and a motorcycle each equipped with a secondary battery of an embodiment;

FIGS. 10A to 10D illustrate electronic devices each equipped with a secondary battery of an embodiment;

FIGS. 11A to 11C illustrate the structure of a sample of an example;

FIG. 12 is a graph showing results of a charge-discharge cycle test on Sample 11 of an example;

FIG. 13 is a graph showing results of the charge-discharge cycle test on Sample 11 of an example;

FIG. 14 is a graph showing results of a charge-discharge cycle test on Sample 12 of an example;

FIG. 15 is a graph showing results of the charge-discharge cycle test on Sample 12 of an example;

FIG. 16 is a graph showing results of a charge-discharge cycle test on Sample 13 of an example;

FIG. 17 is a graph showing results of the charge-discharge cycle test on Sample 13 of an example;

FIG. 18 is a graph showing results of a charge-discharge cycle test on Sample 21 of an example;

FIG. 19 is a graph showing results of the charge-discharge cycle test on Sample 21 of an example;

FIG. 20 is a graph showing results of a charge-discharge cycle test on Sample 22 of an example;

FIG. 21 is a graph showing results of the charge-discharge cycle test on Sample 22 of an example;

FIG. 22 is a graph showing results of a charge-discharge cycle test on Sample 23 of an example;

FIG. 23 is a graph showing results of the charge-discharge cycle test on Sample 23 of an example;

FIG. 24 is a graph showing results of a charge-discharge cycle test on Sample 31 of an example;

FIG. 25 is a graph showing results of the charge-discharge cycle test on Sample 31 of an example;

FIG. 26 is a graph showing results of a charge-discharge cycle test on Sample 32 of an example;

FIG. 27 is a graph showing results of the charge-discharge cycle test on Sample 32 of an example;

FIG. 28 is a graph showing results of a charge-discharge cycle test on Sample 33 of an example;

FIG. 29 is a graph showing results of the charge-discharge cycle test on Sample 33 of an example;

FIG. 30 is a graph showing results of a charge-discharge cycle test on Comparative sample 11 of an example;

FIG. 31 is a graph showing results of the charge-discharge cycle test on Comparative sample 11 of an example;

FIG. 32 is a graph showing results of a charge-discharge cycle test on Sample 41 of an example;

FIG. 33 is a graph showing results of the charge-discharge cycle test on Sample 41 of an example;

FIG. 34 is a graph showing results of a charge-discharge cycle test on Comparative sample 41 of an example; and

FIG. 35 is a graph showing results of the charge-discharge cycle test on Comparative sample 41 of an example.

### DETAILED DESCRIPTION OF THE INVENTION

A secondary battery of one embodiment of the present invention includes a positive electrode active material layer, a negative electrode active material layer, and a separator. The separator is interposed between the positive electrode active material layer and the negative electrode active material layer. The negative electrode active material layer includes silicon particles and a binder. The weight ratio of the binder to the silicon particles is greater than or equal to 0.05 and less than or equal to 10. The binder has a carboxy group, and the bulk specific gravity of the silicon particles is greater than or equal to 0.02 g/cm³ and less than or equal to 0.5 g/cm³.

Thus, the silicon particles can be bound to each other with the use of the binder. In addition, at least part of the surfaces of the silicon particles can be covered and protected with the binder. The binder has a carboxy group, and an oxygen atom of the carboxy group has an unshared electron pair. In the electrolyte solution, lithium ions are stabilized by solvation. The existence of the unshared electron pair near silicon particles can contribute to the stability of the lithium ions. Furthermore, the silicon particles can be protected from a side reaction at the time of charging and discharging of the secondary battery. Moreover, a reaction caused between the ionic liquid and the silicon particles can be inhibited. As a result, a novel secondary battery that is highly convenient, useful, or reliable can be provided.

Embodiments will be described in detail with reference to the drawings. Note that the embodiments of the present invention are not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

In this embodiment, a secondary battery of one embodiment of the present invention is described with reference to FIGS. TA to 1C.

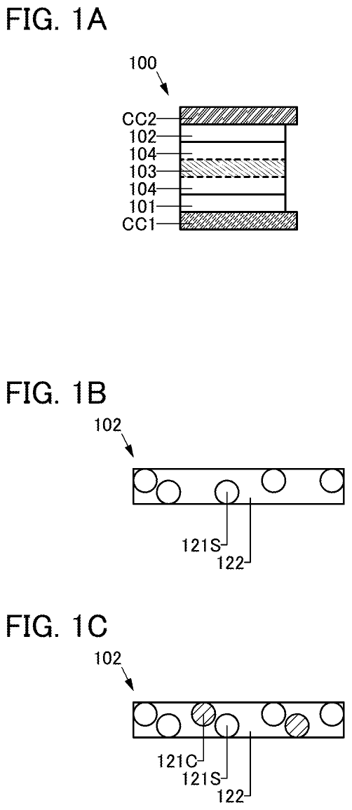

FIG. TA is a cross-sectional view illustrating the structure of the secondary battery of one embodiment of the present invention. FIGS. 1B and 1C are each a cross-sectional view illustrating part of FIG. TA. Note that they are all schematic views and do not represent the details of the structure of the secondary battery of one embodiment of the present invention.

### <Structure Example of Secondary Battery>

A secondary battery 100 described in this embodiment includes a positive electrode, a negative electrode, and a separator 103. The positive electrode includes a positive electrode active material layer 101 and a positive electrode current collector CC1, and the positive electrode active material layer 101 is in contact with the positive electrode current collector CC1. The negative electrode includes a negative electrode active material layer 102 and a negative electrode current collector CC2, and the negative electrode active material layer 102 is in contact with the negative electrode current collector CC2 (see FIG. 1A). The separator 103 is interposed between the positive electrode active material layer 101 and the negative electrode active material layer 102.

The secondary battery 100 further includes an electrolyte solution 104. The electrolyte solution 104 is interposed between the positive electrode active material layer 101 and the negative electrode active material layer 102. Note that both the positive electrode active material layer 101 and the negative electrode active material layer 102 have minute structures on their surfaces, and the electrolyte solution 104 fills spaces of the minute structure. The separator 103 has pores, and the electrolyte solution 104 fills the pores and can pass through the pores.

### <<Structure Example 1 of Negative Electrode Active Material Layer 102>>

The negative electrode active material layer 102 includes silicon particles 121S and a binder 122. The weight ratio of the binder 122 to the silicon particles 121S is greater than or equal to 0.05 and less than or equal to 10.

### [Structure Example of Binder 122]

The binder 122 has a carboxy group. Note that it can be expected that the binder 122 has a function like a solid electrolyte because a carboxy group has high polarity. The binder 122 can cover the surfaces of the silicon particles 121S to reduce the contact area between the silicon particles 121S and the electrolyte solution 104. Thus, the silicon particles 121S and the electrolyte solution 104 can be inhibited from react with each other, so that an effect of improvement in charge-discharge cycle performance can be expected.

For example, polyglutamic acid can be used as the binder 122.

For another example, polyacrylic acid can be used as the binder 122.

With the use of the binder 122, the silicon particles 121S can be dispersed into the slurry with stability. Furthermore, the viscosity of the slurry can be adjusted. As a result, a novel secondary battery that is highly convenient, useful, or reliable can be provided.

### [Structure Example of Silicon Particles 121S]

For example, silicon particles with bulk specific gravity of greater than or equal to 0.02 g/cm³ and less than or equal to 0.5 g/cm³, preferably greater than or equal to 0.02 g/cm³ and less than or equal to 0.1 g/cm³ can be used as the silicon particles 121S.

### <<Composition Example of Electrolyte Solution 104>>

The electrolyte solution 104 contains an ionic liquid. For example, lithium bis(fluorosulfonyl)imide or 1-ethyl-3-methylimidazolium bis(fluorosulfonyl)imide can be used for the electrolyte solution 104.

Thus, the silicon particles 121S can be bound to each other with the use of the binder 122. In addition, at least part of the surfaces of the silicon particles 121S can be covered and protected with the binder 122. The binder 122 has a carboxy group, and an oxygen atom of the carboxy group has an unshared electron pair. In the electrolyte solution 104, lithium ions are stabilized by solvation. The existence of the unshared electron pair near the silicon particles 121S can contribute to the stability of the lithium ions. Furthermore, the silicon particles 121S can be protected from a side reaction at the time of charging and discharging of the secondary battery. Moreover, a reaction caused between the ionic liquid and the silicon particles 121S can be inhibited. As a result, a novel secondary battery that is highly convenient, useful, or reliable can be provided.

### <<Structure Example 2 of Negative Electrode Active Material Layer 102>>

The negative electrode active material layer 102 contains graphite 121C. For example, the weight ratio of the graphite 121C to the silicon particles 121S can be greater than 0 and less than or equal to 19.

Thus, metal ions can be occluded or released by/from not only the silicon particles 121S but also the graphite 121C. Furthermore, the graphite 121C can be bound with the use of the binder 122. As a result, a novel secondary battery that is highly convenient, useful, or reliable can be provided

### <<Example of Method for Fabricating Negative Electrode>>

The negative electrode can be fabricated by a method including the following four steps.

### [First Step]

Predetermined amounts of materials are weighed and mixed uniformly, whereby a mixture is obtained. Specifically, a predetermined amount of the silicon particles 121S and a predetermined amount of the binder 122 are weighed.

For example, another negative electrode active material and a conductive additive may be added to the above-described materials. Specifically, graphite particles and acetylene black can be added to the above-described materials.

### [Second Step]

Next, a solvent is added to the mixture, and the mixture is mixed uniformly with the use of a planetary centrifugal mixing and defoaming machine to obtain a slurry. For example, deionized water can be used as the solvent.

### [Third Step]

Next, the slurry is applied to the negative electrode current collector CC2 using an applicator to form a coating film, and then drying is performed.

### [Fourth Step]

Subsequently, the coating film is expanded using a calendar roll to form a negative electrode active material layer. By the above method, the negative electrode can be fabricated.

### <<Structure Example of Positive Electrode Active Material Layer 101>>

The positive electrode active material layer 101 contains a positive electrode active material and may further contain at least one of a conductive additive and a binder.

As the positive electrode active material, one or more of composite oxide having a layered rock-salt structure, composite oxide having an olivine structure, and composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composite oxide having a layered rock-salt structure can be represented by a composition formula LiM1O₂ (M1 is one or more selected from nickel, cobalt, manganese, and aluminum), in which the coefficient is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composite oxide having an olivine structure can be represented by a composition formula LiM2PO₄ (M2 is one or more selected from iron, manganese, and cobalt), in which the coefficient is not limited to an integer.

Furthermore, composite oxide having a spinel structure, e.g., LiMn₂O₄, can be used.

The contents in this embodiment can be combined with any of the contents in the other embodiments as appropriate.

### Embodiment 2

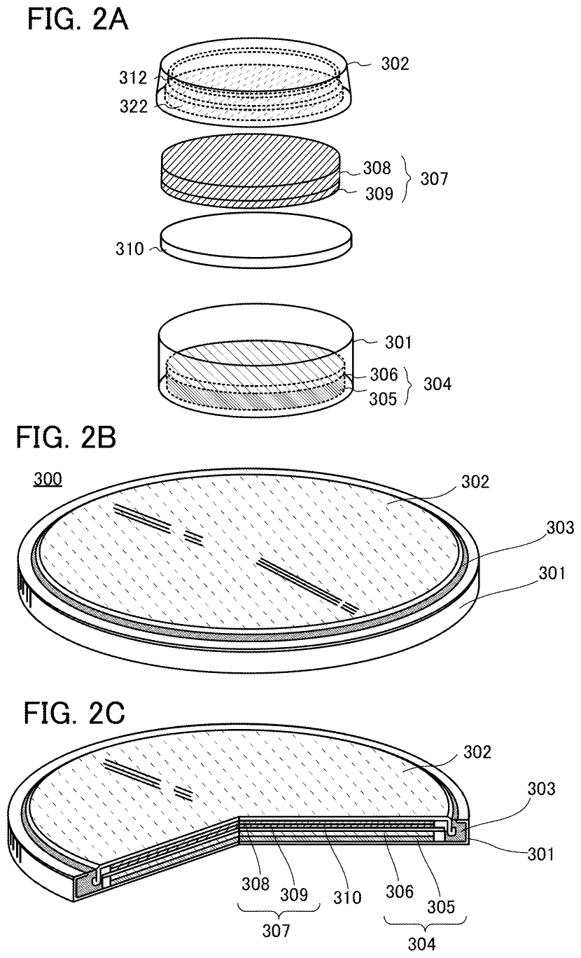

In this embodiment, a secondary battery of one embodiment of the present invention is described with reference to FIGS. 2A to 2C.

FIG. 2A is an exploded perspective view of the secondary battery of one embodiment of the present invention, FIG. 2B is an external view thereof, and FIG. 2C is a cross-sectional view thereof. Note that FIG. 2A is a schematic illustration to make it easier to see how the members overlap one another (the positional relationship among them). Accordingly, part of FIG. 2A does not correspond to FIG. 2B.

### <Coin-Type Secondary Battery>

The secondary battery of one embodiment of the present invention has a coin-type (single-layer flat-type) shape, for example. The coin-type secondary battery is mainly used in a small electronic device.

In FIG. 2A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 2A. The spacer 322 and the washer 312 are used to protect the inside or fix the position of the components inside the cans at the time when the positive electrode can 301 and the negative electrode can 302 are bonded with pressure. Stainless steel is used for the spacer 322 and the washer 312, and an insulating material is used for the gasket and the separator.

In a coin-type secondary battery 300, the positive electrode can 301 doubling as a positive electrode terminal and the negative electrode can 302 doubling as a negative electrode terminal are insulated from each other and sealed by a gasket 303 made of polypropylene (see FIG. 2B).

The positive electrode 304 includes a positive electrode current collector 305 and a positive electrode active material layer 306 provided in contact with the positive electrode current collector 305.

For example, a lithium metal foil or a foil of an alloy of a lithium metal and aluminum can be used as the negative electrode 307. A negative electrode current collector 308 and a negative electrode active material layer 309 provided in contact with the negative electrode current collector 308 can be used as the negative electrode 307. For example, the negative electrode active material layer described in Embodiment 1 can be used as the negative electrode 307.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel or aluminum in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution or an ionic liquid. Then, as illustrated in FIG. 2C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

The separator 310 can be formed using, for example, fiber containing cellulose, such as paper, nonwoven fabric, glass fiber, ceramics, or synthetic fiber containing a nylon resin (poly amide), a vinylon resin (polyvinyl alcohol-based fiber), a polyester resin, an acrylic resin, a polyolefin resin, or a polyurethane resin.

The separator 310 may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in charging at high voltage and discharging can be reduced and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

With the above structure, the coin-type secondary battery 300 can have excellent charge-discharge performance.

The contents in this embodiment can be combined with any of the contents in the other embodiments as appropriate.

### Embodiment 3

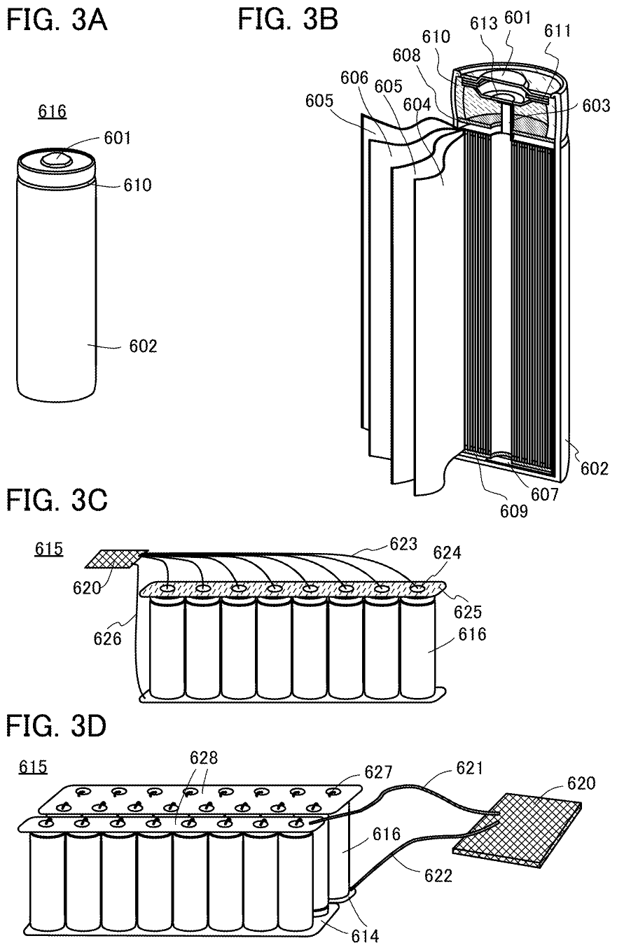

In this embodiment, a secondary battery of one embodiment of the present invention is described with reference to FIGS. 3A to 3D.

FIG. 3A is an external view illustrating the structure of a cylindrical secondary battery of one embodiment of the present invention, and FIG. 3B is an exploded perspective view of the secondary battery. FIGS. 3C and 3D illustrate a power storage system using the secondary battery of one embodiment of the present invention.

### <Cylindrical Secondary Battery>

As illustrated in FIG. 3A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 3B schematically illustrates a cross section of the cylindrical secondary battery. The cylindrical secondary battery illustrated in FIG. 3B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a wound body in which a strip-like positive electrode 604 and a strip-like negative electrode 606 are wound with a strip-like separator 605 located therebetween is provided. Although not illustrated, the wound body is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel and aluminum in order to prevent corrosion due to the electrolyte solution. Inside the battery can 602, the wound body in which the positive electrode, the negative electrode, and the separator are wound is provided between a pair of insulating plates 608 and 609 which face each other. The inside of the battery can 602 provided with the wound body is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical secondary battery are wound, active materials are preferably formed on both sides of the current collectors.

For example, the negative electrode active material layer described in Embodiment 1 can be used in the negative electrode 606. This makes it possible to obtain the cylindrical secondary battery 616 having high charge-discharge cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

FIG. 3C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge-discharge control circuit or a protection circuit for preventing overcharge and/or overdischarge can be used.

FIG. 3D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in parallel and then those sets may be connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 3D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

<Secondary Battery Provided with Wound Body>

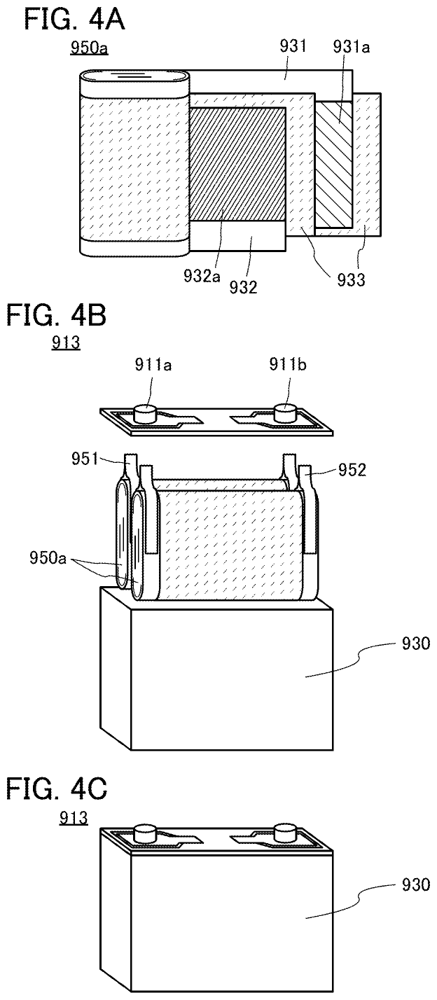

A secondary battery of one embodiment of the present invention is provided with a wound body, for example. An example of the secondary battery provided with the wound body is described with reference to FIGS. 4A to 4C.

A secondary battery 913 of one embodiment of the present invention includes a wound body 950a (see FIG. 4A). The wound body 950a includes a negative electrode 931, a positive electrode 932, and separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap the negative electrode active material layer 931a and the positive electrode active material layer 932a.

For example, the negative electrode active material layer described in Embodiment 1 can be used in the negative electrode 931. This makes it possible to obtain the secondary battery 913 having high charge-discharge cycle performance.

In terms of safety, the width of the negative electrode active material layer 931a is preferably larger than that of the positive electrode active material layer 932a. The wound body 950a having such a shape is preferable because of its high degree of safety and high productivity.

As illustrated in FIG. 4B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 4C, the wound body 950a and an electrolyte solution are covered with a housing 930, whereby the secondary battery 913 is completed. The housing 930 is preferably provided with a safety valve and an overcurrent protection element. For the housing 930, a metal material (e.g., aluminum) can be used. A safety valve is a valve to be released by a predetermined internal pressure of the housing 930 in order to prevent the battery from exploding.

As illustrated in FIG. 4B, the secondary battery 913 may include a plurality of wound bodies 950a. The use of the plurality of wound bodies 950a enables the secondary battery 913 to have higher discharge capacity.

### <Laminated Secondary Battery>

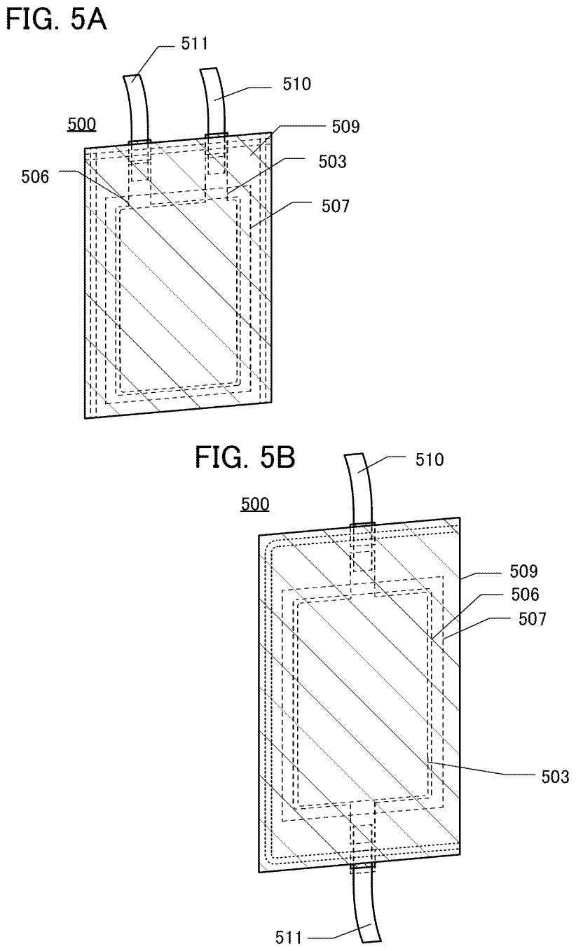

Next, examples of the appearance of a laminated secondary battery are illustrated in FIGS. 5A and 5B. The laminated secondary battery illustrated in FIGS. 5A and 5B includes a positive electrode 503, a negative electrode 506, a separator 507, an exterior body 509, a positive electrode lead electrode 510, and a negative electrode lead electrode 511.

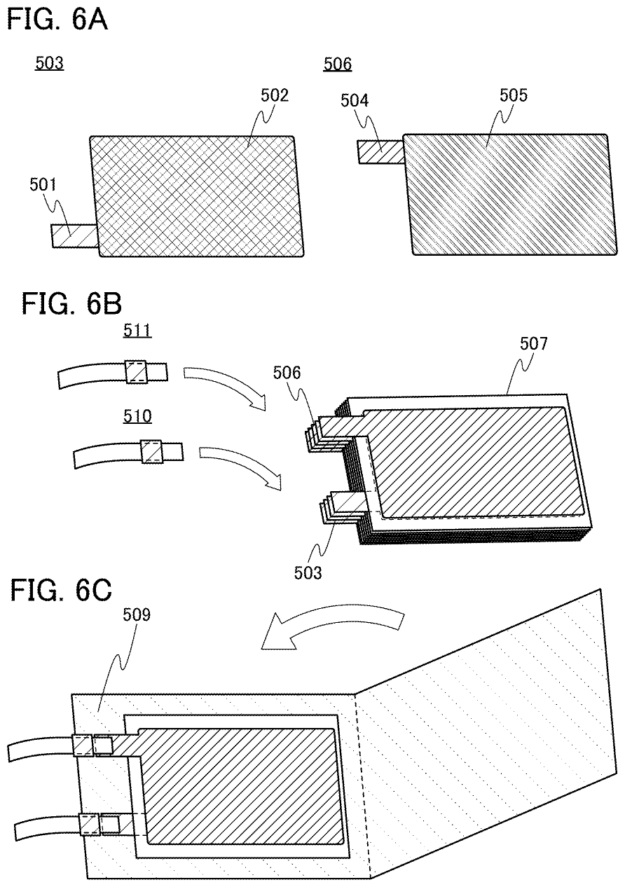

FIG. 6A illustrates the appearances of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 6A.

### <Method for Fabricating Laminated Secondary Battery>

An example of a method for fabricating the laminated secondary battery having the appearance illustrated in FIG. 5A is described with reference to FIGS. 6B and 6C.

First, the negative electrode 506, the separator 507, and the positive electrode 503 are stacked. FIG. 6B illustrates the stack including the negative electrode 506, the separator 507, and the positive electrode 503. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 6C. Then, the outer edges of the exterior body 509 are bonded to each other. The bonding can be performed by thermocompression. At this time, apart (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

For example, the negative electrode active material layer described in Embodiment 1 can be used in the negative electrode 506. This makes it possible to obtain the secondary battery 500 having high charge-discharge cycle performance.

The contents in this embodiment can be combined with any of the contents in the other embodiments as appropriate.

### Embodiment 4

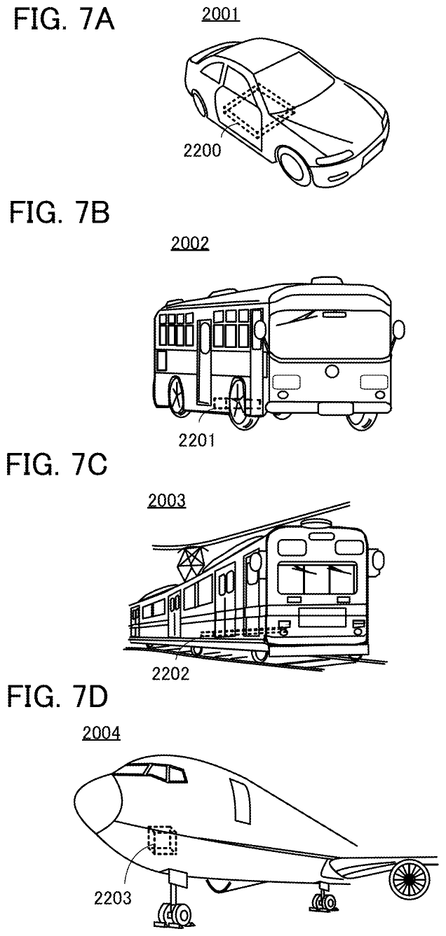

In this embodiment, vehicles each equipped with the secondary battery of one embodiment of the present invention are described with reference to FIGS. 7A to 7D.

FIGS. 7A to 7D illustrate examples of transport vehicles each equipped with the secondary battery of one embodiment of the present invention.

The use of a plurality of secondary batteries of one embodiment of the present invention in vehicles can lead to next-generation clean energy vehicles such as hybrid electric vehicles (HEVs), electric vehicles (EVs), and plug-in hybrid electric vehicles (PHEVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be highly safe. The secondary battery of one embodiment of the present invention has a long lifetime and thus is preferably used in transport vehicles.

An automobile 2001 illustrated in FIG. 7A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 3 is provided at one position or several positions. The automobile 2001 illustrated in FIG. 7A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charge equipment by a plug-in system, a contactless power feeding system, or the like. In charge, a given method such as CHAdeMO (registered trademark) or Combined Charging System can be employed as a charging method, the standard of a connector, or the like as appropriate. A charge equipment may be a charging station provided in a commerce facility or a power source in a house. For example, with the use of the plug-in technique, the power storage device mounted on the automobile 2001 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 7B illustrates a large transporter 2002 having a motor controlled by electricity as an example of a transport vehicle. A secondary battery module of the transporter 2002 includes, for example, a cell unit of four secondary batteries with a nominal voltage of 3.0 V or higher and 5.0 V or lower, and 48 cells are connected in series to have a maximum voltage of 170 V. A battery pack 2201 has the same function as that in FIG. 7A except, for example, the number of secondary batteries configuring the secondary battery module; thus, the description is omitted.

FIG. 7C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V. The secondary battery of one embodiment of the present invention exhibits favorable rate performance and favorable charge-discharge cycle performance and can contribute to an improvement in the performance and lengthening of the lifetime of the transport vehicle 2003. A battery pack 2202 has the same function as that in FIG. 7A except the number of secondary batteries configuring the secondary battery module; thus, the description is omitted.

FIG. 7D illustrates an aircraft 2004 having a combustion engine as an example. The aircraft 2004 illustrated in FIG. 7D can be regarded as one kind of transport vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series, which has the maximum voltage of 32 V, for example. The battery pack 2203 has the same function as that in FIG. 7A except, for example, the number of secondary batteries configuring the secondary battery module; thus, the description is omitted.

The contents in this embodiment can be combined with any of the contents in the other embodiments as appropriate.

### Embodiment 5

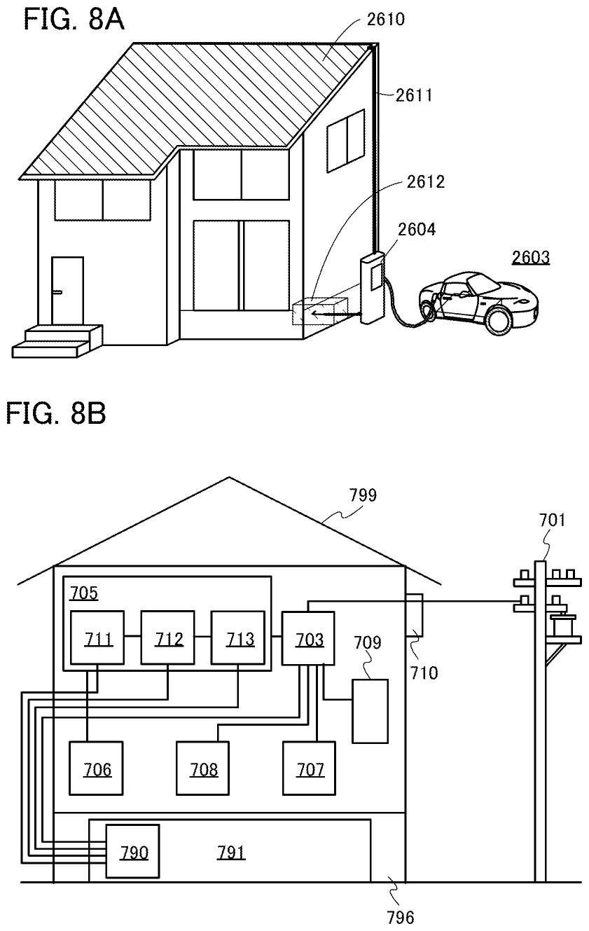

In this embodiment, a building provided with the secondary battery of one embodiment of the present invention is described with reference to FIGS. 8A and 8B.

A house illustrated in FIG. 8A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in an underfloor space. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, indoor use of an electronic device becomes possible with the use of the power storage device 2612 of one embodiment of the present invention as an uninterruptible power source even when electric power cannot be supplied from the commercial power supply due to power failure.

FIG. 8B illustrates an example of a power storage device of one embodiment of the present invention. As illustrated in FIG. 8B, a power storage device 791 of one embodiment of the present invention is provided in an underfloor space 796 of a building 799. The use of the secondary battery of one embodiment of the present invention as the power storage device 791 enables the power storage device 791 to have a high discharge capacity.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, and the portable electronic terminal can also show the demand for electric power depending on a time period (or per hour) that is predicted by the predicting portion 712.

The contents in this embodiment can be combined with any of the contents in the other embodiments as appropriate.

### Embodiment 6

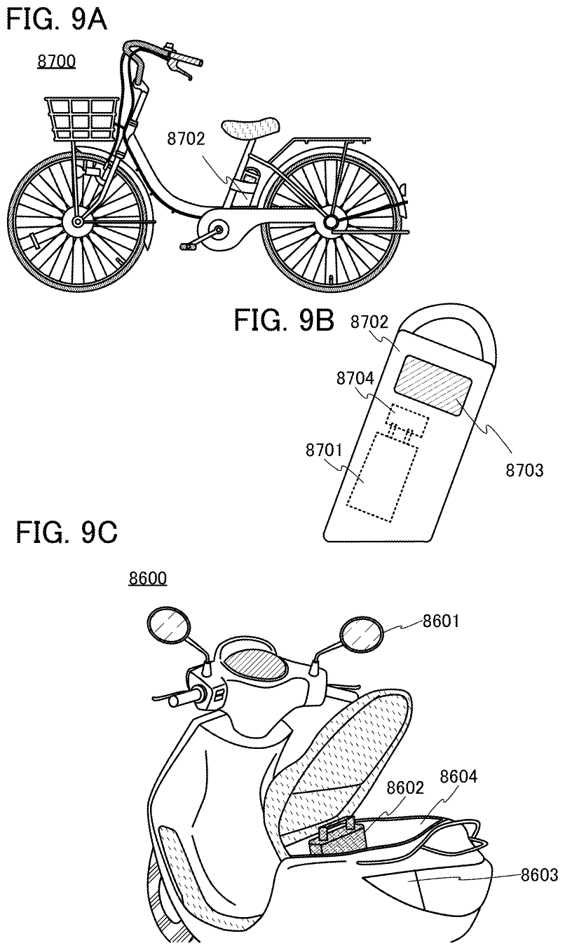

In this embodiment, a motorcycle and a bicycle each equipped with the secondary battery of one embodiment of the present invention are described with reference to FIGS. 9A to 9C.

FIG. 9A illustrates an example of an electric bicycle using the power storage device of one embodiment of the present invention. The power storage device of one embodiment of the present invention can be used in an electric bicycle 8700 illustrated in FIG. 9A. The power storage device of one embodiment of the present invention includes a plurality of secondary batteries and a protection circuit, for example.

The electric bicycle 8700 is provided with a power storage device 8702. The power storage device 8702 can supply electric power to a motor that assists a rider. The power storage device 8702 is portable, and FIG. 9B shows the state where the power storage device 8702 is removed from the electric bicycle. The power storage device 8702 incorporates a plurality of secondary batteries 8701 included in the power storage device of one embodiment of the present invention, and can display the remaining battery level on a display portion 8703. The power storage device 8702 includes a control circuit 8704 capable of charge control or anomaly detection for the secondary battery. The control circuit 8704 is electrically connected to a positive electrode and a negative electrode of the secondary battery 8701.

Alternatively, the secondary battery of one embodiment of the present invention may be provided separately to supply electric power for driving the control circuit 8704. Thus, the data retention time of a memory circuit included in the control circuit 8704 can be lengthened.

FIG. 9C illustrates an example of a motorcycle using the power storage device of one embodiment of the present invention. A motor scooter 8600 illustrated in FIG. 9C includes a power storage device 8602, side mirrors 8601, and indicators 8603. The power storage device 8602 can supply electric power to the indicators 8603. The power storage device 8602 including a plurality of secondary batteries of one embodiment of the present invention can have high capacity and contribute to a reduction in size.

In the motor scooter 8600 illustrated in FIG. 9C, the power storage device 8602 can be held in an under-seat storage unit 8604. The power storage device 8602 can be held in the under-seat storage unit 8604 even with a small size.

The contents in this embodiment can be combined with any of the contents in the other embodiments as appropriate.

### Embodiment 7

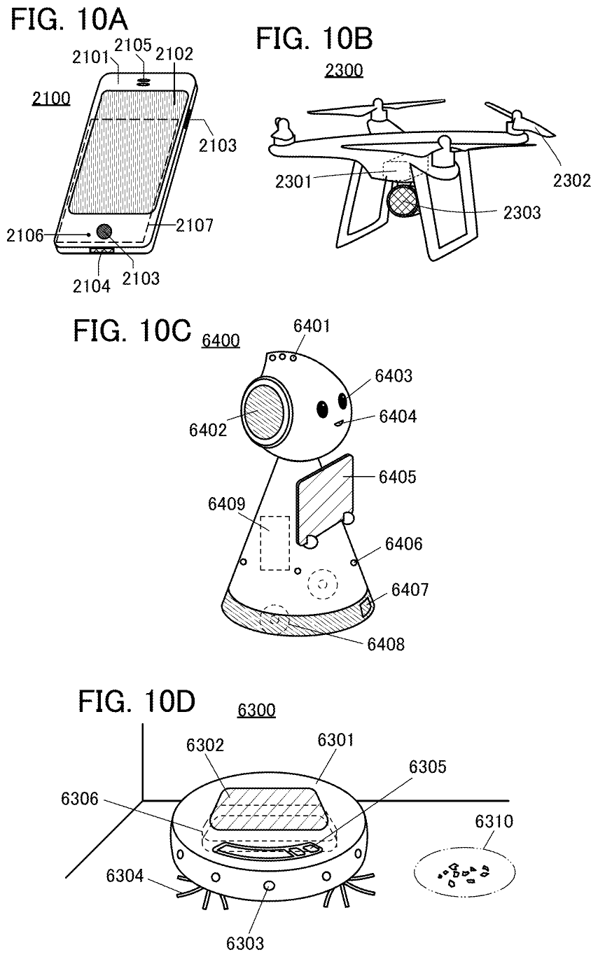

In this embodiment, electronic devices each equipped with the secondary battery of one embodiment of the present invention will be described with reference to FIGS. 10A to 10D.

Examples of the electronic device provided with the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

FIG. 10A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. With the use of the secondary battery of one embodiment of the present invention, space saving required with downsizing of a housing can be achieved.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. In that case, for example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 10B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention has favorable charge-discharge cycle performance and thus is preferred as the secondary battery mounted on the unmanned aircraft 2300.

FIG. 10C illustrates an example of a robot. A robot 6400 illustrated in FIG. 10C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. The secondary battery of one embodiment of the present invention has favorable charge-discharge cycle performance and thus is preferred as the secondary battery 6409 mounted on the robot 6400.

FIG. 10D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. The secondary battery of one embodiment of the present invention has favorable charge-discharge cycle performance and thus is preferred as the secondary battery 6306 mounted on the cleaning robot 6300.

The contents in this embodiment can be combined with any of the contents in the other embodiments as appropriate.

### Example 1

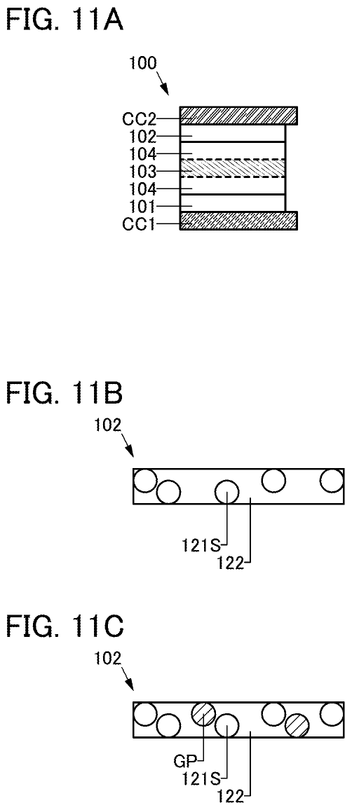

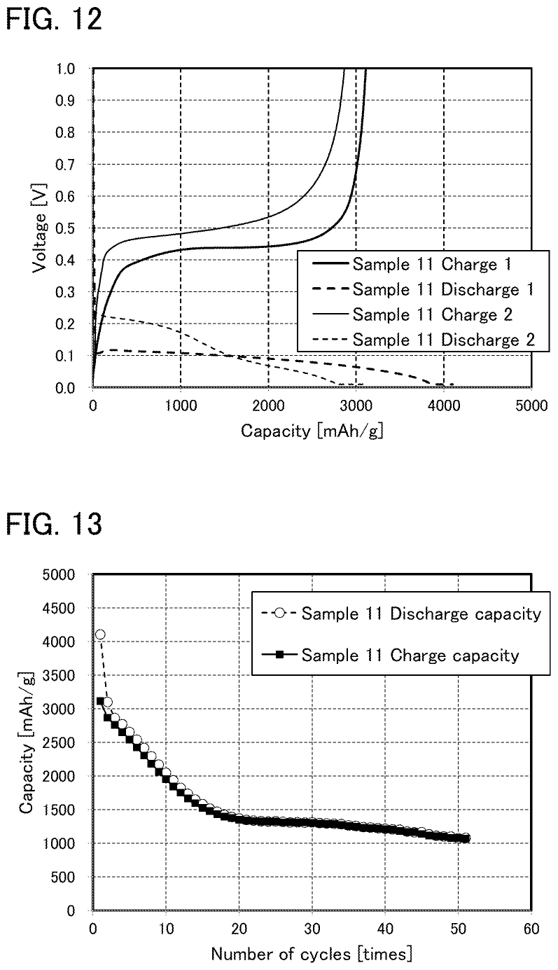

In this example, samples each provided with a negative electrode active material layer that can be used for the secondary battery of one embodiment of the present invention are described with reference to FIGS. 11A to 11C, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, and FIG. 31.

FIGS. 11A to 11C illustrate the structure of the secondary battery 100.

FIG. 12 shows results of a charge-discharge cycle test on Sample 11.

FIG. 13 shows results of the charge-discharge cycle test on Sample 11.

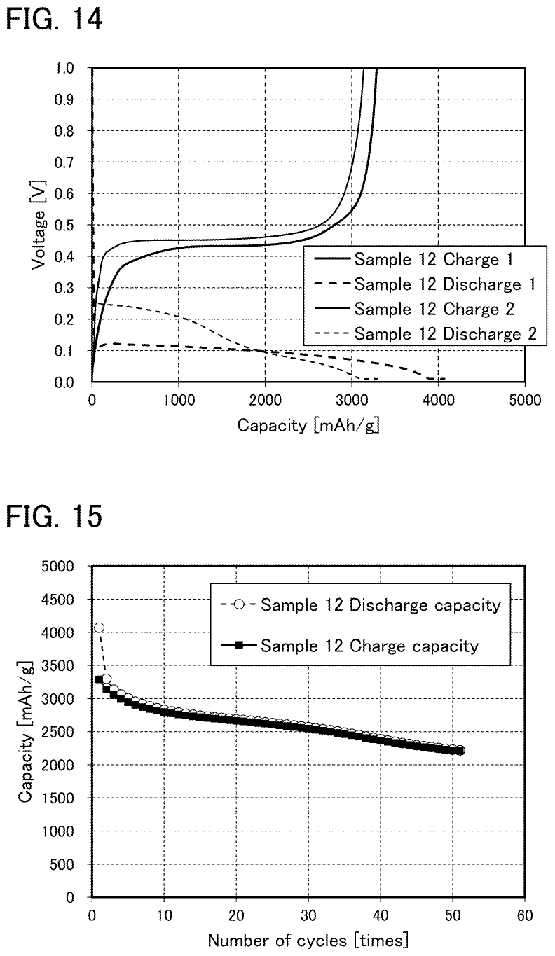

FIG. 14 shows results of a charge-discharge cycle test on Sample 12.

FIG. 15 shows results of the charge-discharge cycle test on Sample 12.

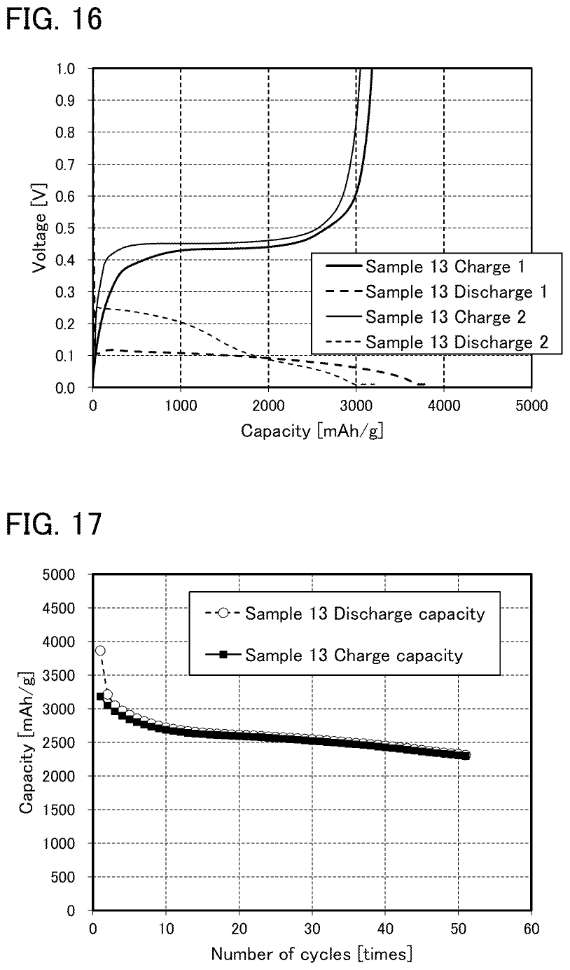

FIG. 16 shows results of a charge-discharge cycle test on Sample 13.

FIG. 17 shows results of the charge-discharge cycle test on Sample 13.

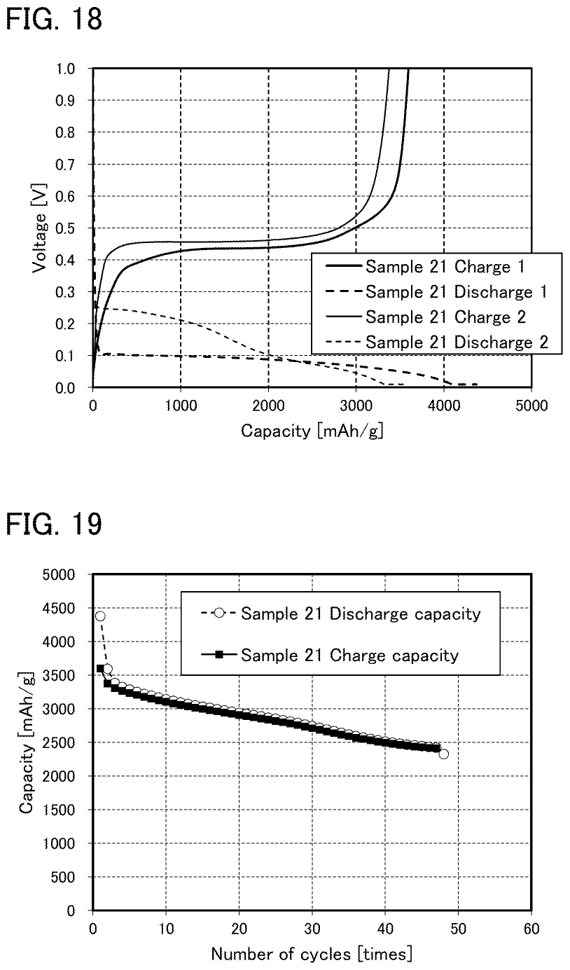

FIG. 18 shows results of a charge-discharge cycle test on Sample 21.

FIG. 19 shows results of the charge-discharge cycle test on Sample 21.

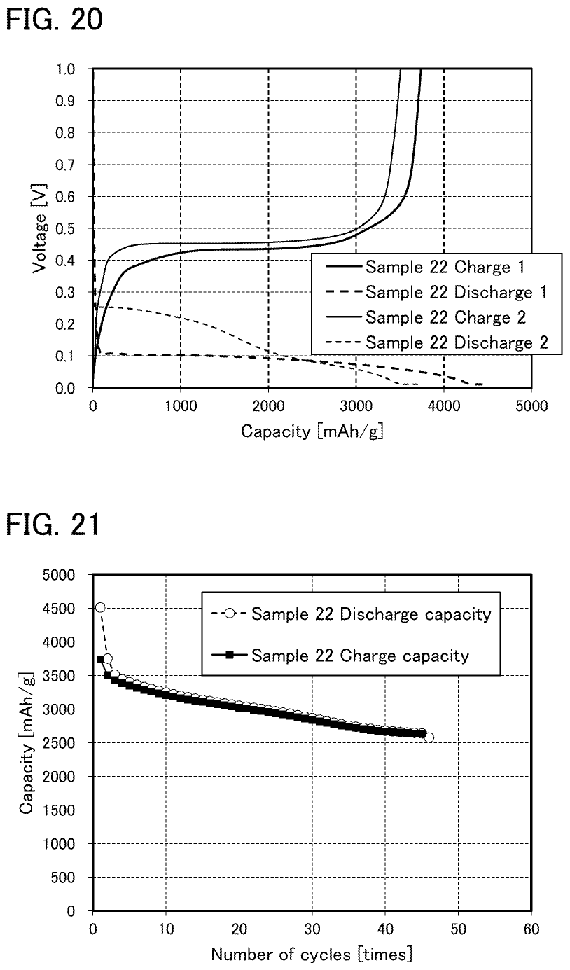

FIG. 20 shows results of a charge-discharge cycle test on Sample 22.

FIG. 21 shows results of the charge-discharge cycle test on Sample 22.

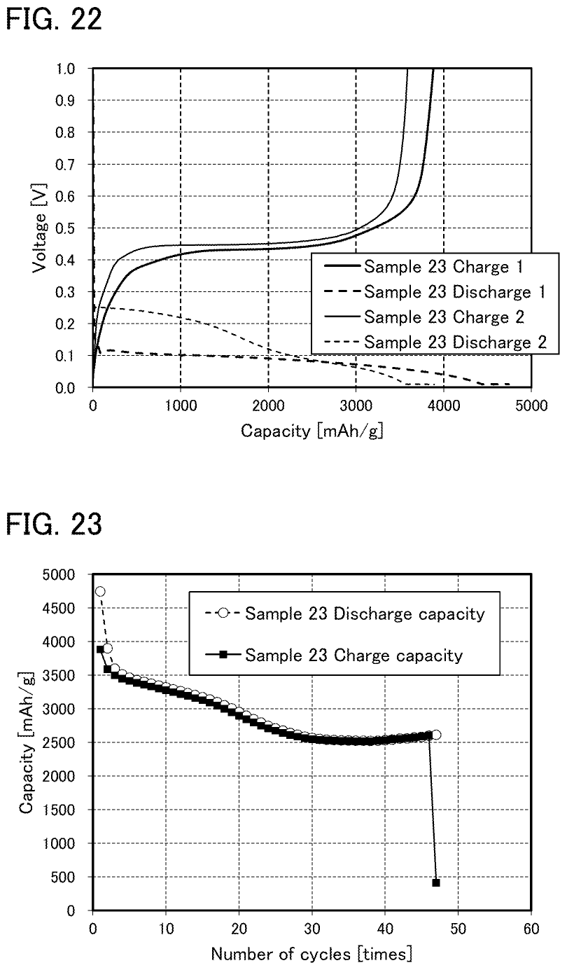

FIG. 22 shows results of a charge-discharge cycle test on Sample 23.

FIG. 23 shows results of the charge-discharge cycle test on Sample 23.

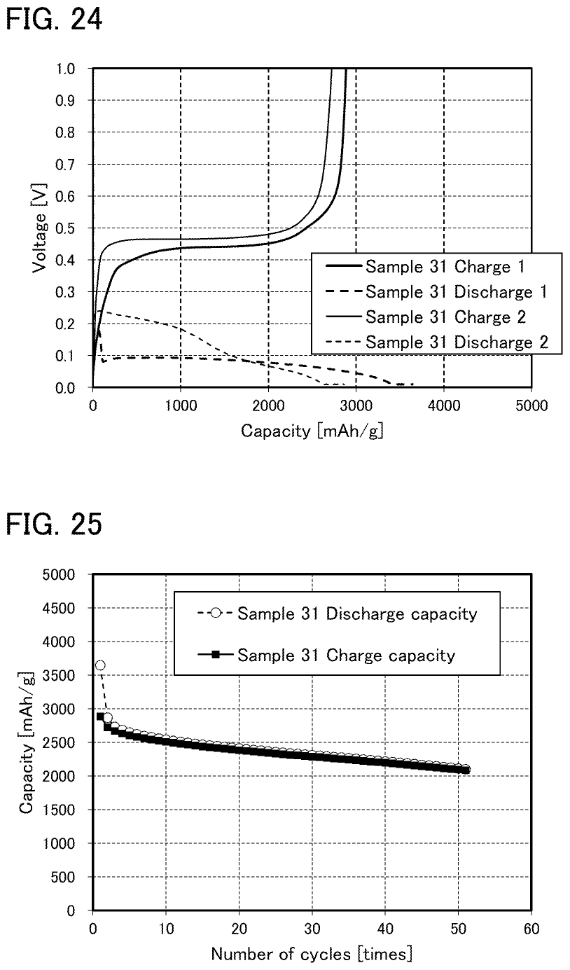

FIG. 24 shows results of a charge-discharge cycle test on Sample 31.

FIG. 25 shows results of the charge-discharge cycle test on Sample 31.

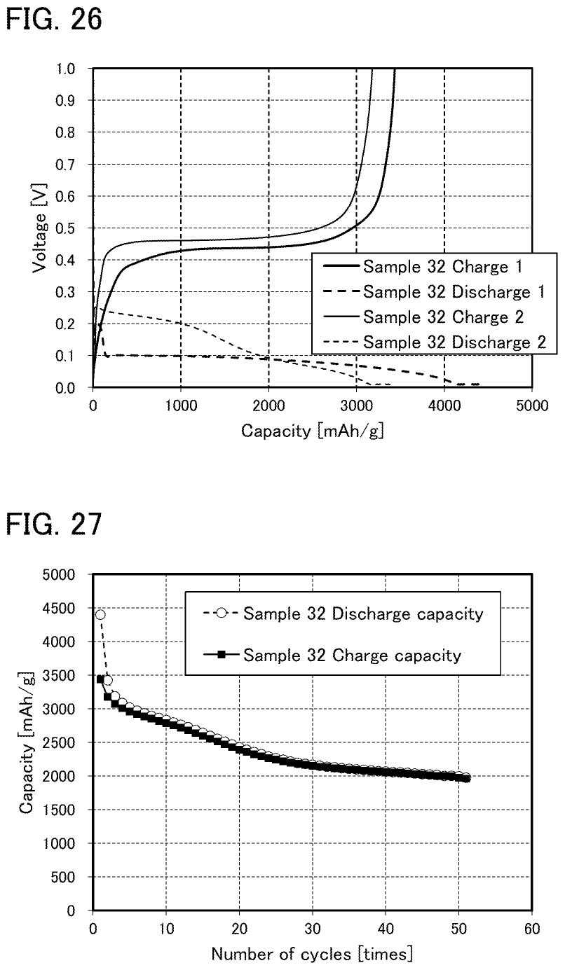

FIG. 26 shows results of a charge-discharge cycle test on Sample 32.

FIG. 27 shows results of the charge-discharge cycle test on Sample 32.

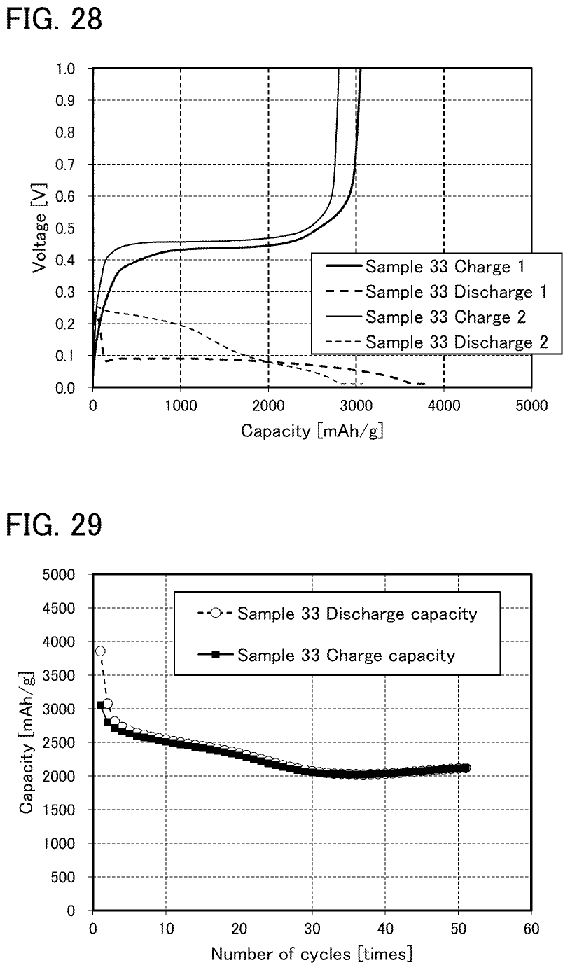

FIG. 28 shows results of a charge-discharge cycle test on Sample 33.

FIG. 29 shows results of the charge-discharge cycle test on Sample 33.

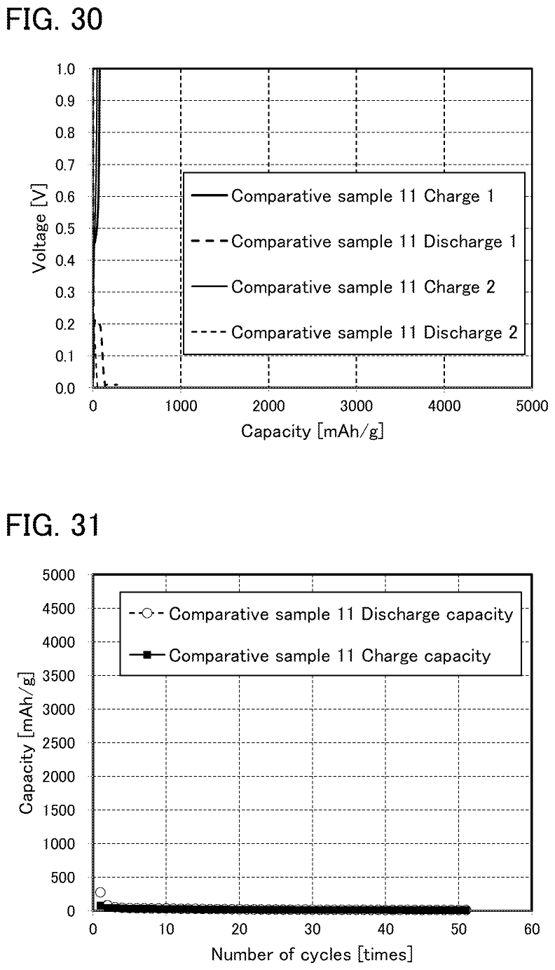

FIG. 30 shows results of a charge-discharge cycle test on Comparative sample 11.

FIG. 31 shows results of the charge-discharge cycle test on Comparative sample 11.

### <Samples 11 to 13>

The samples fabricated in this example each have a coin-type half cell structure. Note that a can made of stainless-steel (SUS) was used for each of the positive electrode can and the negative electrode can. In addition, 1-ethyl-3-methylimidazolium bis(fluorosulfonyl)imide (abbreviation: EMI-FSI) containing lithium bis(fluorosulfonyl)imide (abbreviation: LiFSI) at a concentration of 2.15 mol/L was used as the electrolyte solution, and porous polypropylene (abbreviation: PP) was used as the separator.

Samples 11 to 13 fabricated in this example each include a negative electrode active material layer (see FIG. 11A). The negative electrode active material layer 102 includes the silicon particles 121S and the binder 122 (see FIG. 11B). The weight ratio of the binder 122 to the silicon particles 121S is greater than or equal to 5/95 and less than or equal to 20/80.

The binder 122 has a carboxy group. Specifically, polyglutamic acid (PGA) was used as the binder 122.

### <<Structures of Samples 11 to 13>>

The structures of Samples 11 to 13 are described using Tables 1 and 2. Samples 11 to 13 have the same structures except for the composition of the negative electrode active material layer 102 (see Table 1). The weight ratio of the materials forming the negative electrode active material layer 102 are represented with X and Y in Table 1, and the values of X and Y of each of Samples 11 to 13 are shown in Table 2. In addition, the structural formula of polyglutamic acid (PGA) is shown in Chemical formula 1. Note that a negative electrode active material layer that can be used in the secondary battery of one embodiment of the present invention was used for one electrode, and a lithium metal was used for the other electrode.

The materials used in the samples described in this example are shown below. Note that in the tables in this example, subscript and superscript characters are written in ordinary size for convenience. For example, a subscript character in an abbreviation or a superscript character in a unit are written in ordinary size in the tables. The corresponding description in the specification gives an accurate reading of such notations in the tables.

TABLE 1

| | Reference | | Weight |
|---|---|---|---|
| Component | numeral | Material | ratio |
| Current collector | CC2 | Copper foil | |
| Negative electrode | 102 | Si-A:PGA | X:Y |
| active material layer | | | |
| Electrolyte solution | 104 | LiFSI:EMI-FSI | |
| Separator | 103 | PP | |
| Electrode | | Li | |

TABLE 2

| | Si-A | PGA | |
|---|---|---|---|
| | X | Y | |
| Sample 11 | 95 | 5 | (Weight ratio) |
| Sample 12 | 90 | 10 | |
| Sample 13 | 80 | 20 | |

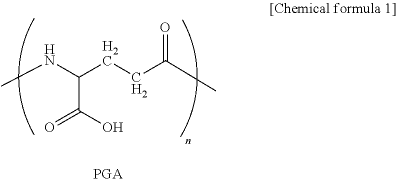

A silicon-nanopowder (produced by Sigma-Aldrich Co. LLC; product No. 633097) was used as silicon particles Si-A. Note that its particle size measured by transmission-electron microscopy is smaller than 100 nm.

The bulk specific gravity of the silicon particles Si-A was measured to be 0.0423 g/cm³. Note that a method for measuring the bulk specific gravity is as follows. A predetermined amount (30 ml) of silicon particles was added to a graduated cylinder, and the volume and weight of the silicon particles were measured. Then, bulk specific gravity was obtained by dividing the weight by the volume.

As the polyglutamic acid (PGA) of the binder 122 of the negative electrode active material layer 102, γ-PGA (CL) produced by Nippon Poly-Glu Co., Ltd was used. Note that the molecular weight is tens of millions.

The polyglutamic acid has hydrophilicity. Furthermore, the polyglutamic acid consists predominantly of γ-polyglutamic acid. In addition, polyglutamic acid serving as a crosslinking substance is used. The crosslinking substance can be prepared by irradiating γ-polyglutamic acid or a salt thereof with radiation. The radiation irradiation causes a dehydrogenation reaction, whereby a radiation cross-linked substance with a large molecular weight can be obtained. The crosslinking of polyglutamic acid can allow the average molecular weight to be tens of millions.

### <<Method for Fabricating Samples 11 to 13>>

Samples 11 to 13 described in this example were fabricated by a method including the following steps.

### [First Step]

Predetermined amounts of materials were weighed and mixed uniformly, whereby a mixture was obtained. Specifically, silicon particles (Si-A) and polyglutamic acid (PGA) were weighed at a weight ratio X:Y and mixed.

### [Second Step]

Next, a solvent was added to the mixture, and the mixture was mixed uniformly with the use of a planetary centrifugal mixing and defoaming machine to obtain a slurry. Note that deionized water was used as the solvent.

### [Third Step]

Next, the slurry was applied to the negative electrode current collector CC2 using an applicator (SA-204) produced by TESTER SANGYO CO., LTD, and then drying was performed. Note that a copper foil was used as the negative electrode current collector.

### [Fourth Step]

Subsequently, the coating film was expanded using a calendar roll (MSC-169) produced by YURI ROLL MACHINE Co., Ltd. to form a negative electrode active material layer.

<<Operation Characteristics of Samples 11 to 13>>

The operation characteristics of Samples 11 to 13 were measured at room temperature (see FIGS. 12 to 17). Note that the measurement of the charge-discharge operation characteristics was performed with a charge-discharge test system (TOSCAT-3000) produced by TOYO SYSTEM Co., LTD.

### [Two-Time Charge-Discharge Cycle Test]

For the first charge-discharge cycle, discharging was performed from 1 V to 0.01 V with a predetermined current at a discharge rate of 0.1 C, and after the voltage reached 0.01 V, the voltage was switched to a constant voltage and discharging was performed (the first discharging). Then, charging was performed at a charge rate of 0.1 C until the voltage reached 1 V (the first charging). Note that these steps are the first charge-discharge cycle. Note that 1 C was calculated from the amount of the active material used assuming that the capacity of the negative electrode active material was 4190 mAh/g.

A one-hour pause time was provided between the first charge-discharge cycle and the second charge-discharge cycle.

For the second charge-discharge cycle, discharging was performed with a predetermined current at a discharge rate of 0.2 C (the second discharging). After that, charging was performed at a charge rate of 0.2 C until the voltage reached 1 V (the second charging).

### [Fifty-Time Charge-Discharge Cycle Test]

In addition, a 50-time charge-discharge cycle test was performed. In the charge-discharge cycle test, a one-hour pause time was provided between the first charge-discharge cycle and the second charge-discharge cycle. Furthermore, a 10-minute pause time was provided between the second charge-discharge cycle and the third charge-discharge cycle. As for the third and subsequent charge-discharge cycles, a 10-minute pause time was provided between the present and next charge-discharge cycles. In the third and subsequent charge-discharge cycles, the charge rate and discharge rate were each set to 0.2 C.

Table 3 shows the characteristics of the fabricated samples together with the loading amount of the negative electrode active material. Note that in this specification, the loading amount refers to the weight of the negative electrode active material per unit surface area of the negative electrode current collector. A discharge capacity is used as an indicator for evaluating the amount of lithium ions occluded by the negative electrode active material layer. Table 3 also shows the characteristics of other samples, whose structures are described later.

TABLE 3

| | | First | First | 51st |
|---|---|---|---|---|
| | Loading | discharge | charge | charge |
| | amount | capacity | capacity | capacity |
| | g/cm³ | mAh/g | mAh/g | mAh/g |
| Sample 11 | 0.543 | 4103 | 3111 | 1066 |
| Sample 12 | 0.498 | 4070 | 3287 | 2208 |
| Sample 13 | 0.522 | 3865 | 3180 | 2296 |
| Sample 21 | 0.574 | 4374 | 3596 | 2381 |
| Sample 22 | 0.564 | 4509 | 3738 | 2611 |
| Sample 23 | 0.399 | 4744 | 3881 | 2673 |
| Sample 31 | 0.822 | 3645 | 2884 | 2085 |
| Sample 32 | 0.692 | 4397 | 3436 | 1962 |
| Sample 33 | 0.66 | 3855 | 3051 | 2120 |
| Comparative sample 11 | 0.557 | 77 | 276 | 11 |
| Sample 41 | 2.37 | 1908 | 1743 | 1318 |
| Comparative sample 41 | 0.73 | 997 | 610 | 658 |

Samples 11 to 13 were found to exhibit favorable characteristics. For example, the first discharge capacities of Samples 11 to 13 were each 3800 mAh/g or higher.

Samples 11 to 13 exhibited better characteristics than Comparative sample 11 described later. The surfaces of the silicon particles are covered with silicon oxide. The silicon oxide film covering the silicon particles inhibits the reaction between silicon and lithium. Thus, it can be considered that a large discharge capacity is obtained by using silicon particles with thin silicon oxide as compared with the case of using silicon particles with thick silicon oxide.

### <Samples 21 to 23>

Samples 21 to 23 fabricated in this example each include a negative electrode active material layer different from those of Samples 11 to 13. Specifically, polyacrylic acid PAH was used as the binder 122. Different portions are described in detail below, and the above description is referred to for portions where a method similar to the above was employed.

### <<Structures of Samples 21 to 23>>

The structures of Samples 21 to 23 are described using Tables 4 and 5. Samples 21 to 23 have the same structures except for the composition of the negative electrode active material layer 102 (see Table 4). The weight ratio of the materials forming the negative electrode active material layer 102 are represented with X and Y in Table 4, and the values of X and Y of each of Samples 21 to 23 are shown in Table 5. In addition, the structural formula of poly(acrylic acid) (PAH) is shown in Chemical formula 2.

TABLE 4

| | Reference | | Weight |
|---|---|---|---|
| Structure | numeral | Material | ratio |
| Current collector | CC2 | Copper foil | |
| Negative electrode | 102 | Si-A:PAH | X:Y |
| active material layer | | | |
| Electrolyte solution | 104 | LiFSI:EMI-FSI | |
| Separator | 103 | PP | |
| Electrode | | Li | |

TABLE 5

| | Si-A | PAH | |
|---|---|---|---|
| | X | Y | |
| Sample 21 | 95 | 5 | (Weight ratio) |
| Sample 22 | 90 | 10 | |
| Sample 23 | 80 | 20 | |

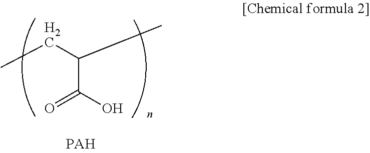

Poly(acrylic acid) (PAH produced by FUJIFILM Wako Pure Chemical Corporation) was used as the binder 122.

### <<Method for Fabricating Samples 21 to 23>>

Samples 21 to 23 described in this example were fabricated by a method including the following steps.

Note that the method for fabricating Samples 21 to 23 is different from the method for fabricating Samples 11 to 13 in that poly(acrylic acid) (PAH) is used as the binder instead of polyglutamic acid (PGA) in First step. Different portions are described in detail below, and the above description is referred to for portions where a method similar to the above was employed.

### [First Step]

Predetermined amounts of materials are weighed and mixed uniformly, whereby a mixture was obtained. Specifically, silicon particles (Si-A) and poly(acrylic acid) (PAH) were weighed at a weight ratio X:Y and mixed.

### <<Operation Characteristics of Samples 21 to 23>>

The operation characteristics of Samples 21 to 23 were measured at room temperature (see FIGS. 18 to 23).

The characteristics of the fabricated samples are shown in Table 3.

Samples 21 to 23 were found to exhibit favorable characteristics. For example, the first discharge capacities of Samples 21 to 23 were each 4300 mAh/g or higher.

### <Samples 31 to 33>

Samples 31 to 33 fabricated in this example each include a negative electrode active material layer different from those of Samples 11 to 13. Specifically, cross-linked poly(acrylic acid) (20CL) was used as the binder 122. Different portions are described in detail below, and the above description is referred to for portions where a method similar to the above was employed.

### <<Structures of Samples 31 to 33>>

The structures of Samples 31 to 33 are described using Tables 6 and 7. Samples 31 to 33 have the same structures except for the composition of the negative electrode active material layer 102 (see Table 6). The weight ratio of the materials forming the negative electrode active material layer 102 are represented with X and Y in Table 6, and the values of X and Y of each of Samples 31 to 33 are shown in Table 7.

TABLE 6

| | Reference | | Weight |
|---|---|---|---|
| Structure | numeral | Material | ratio |
| Current collector | CC2 | Copper foil | |
| Negative electrode | 102 | Si-A:20CL | X:Y |
| active material layer | | | |
| Electrolyte solution | 104 | LiFSI:EMI-FSI | |
| Separator | 103 | PP | |
| Electrode | | Li | |

TABLE 7

| | Si-A | 20CL | |
|---|---|---|---|
| | X | Y | |
| Sample 31 | 95 | 5 | (Weight ratio) |
| Sample 32 | 90 | 10 | |
| Sample 33 | 80 | 20 | |

As the cross-linked poly(acrylic acid) (20CL) of the binder 122 of the negative electrode active material layer 102, 20CLPAH produced by FUJIFILM Wako Pure Chemical Corporation was used as.

### <<Method for Fabricating Samples 31 to 33>>

Samples 31 to 33 described in this example were fabricated by a method including the following steps.

Note that the method for fabricating Samples 31 to 33 is different from the method for fabricating Samples 11 to 13 in that cross-linked poly(acrylic acid) (CL20) is used as the binder instead of polyglutamic acid (PGA) in First step. Different portions are described in detail below, and the above description is referred to for portions where a method similar to the above was employed.

### [First Step]

Predetermined amounts of materials were weighed and mixed uniformly, whereby a mixture was obtained. Specifically, silicon particles (Si-A) and cross-linked poly(acrylic acid) (CL20) were weighed at a weight ratio X:Y and mixed.

### <<Operation Characteristics of Samples 31 to 33>>

The operation characteristics of Samples 31 to 33 were measured at room temperature (see FIGS. 24 to 29).

The characteristics of the fabricated samples are shown in Table 3.

Samples 31 to 33 were found to exhibit favorable characteristics. For example, the first discharge capacities of Samples 31 to 33 were each 3600 mAh/g or higher.

### Comparative Example 1

Comparative sample 11 fabricated in this example includes a negative electrode active material layer different from that of Sample 11. Specifically, silicon particles Si-REF were used as the silicon particles 121S instead of the silicon particles Si-A. Different portions are described in detail below, and the above description is referred to for portions where a method similar to the above was employed.

### <<Structure of Comparative Sample 11>>

Table 8 shows the structure of Comparative sample 11.

TABLE 8

| | Reference | | Weight |
|---|---|---|---|
| Structure | numeral | Material | ratio |
| Current collector | CC2 | Copper foil | |
| Negative electrode | 102 | Si-REF:PGA | 95:5 |
| active material layer | | | |
| Electrolyte solution | 104 | LiFSI:EMI-FSI | |
| Separator | 103 | PP | |
| Electrode | | Li | |

Silicon particles (produced by Hefei Kaier Nano Energy Technology Co., Ltd.) were used as the silicon particles Si-REF.

The bulk specific gravity of the silicon particles Si-REF was measured to be 0.1126 g/cm³.

### <<Method for Fabricating Comparative Sample 11>>

Comparative sample 11 described in this example was fabricated by a method including the following steps.

Note that the method for fabricating Comparative sample 11 is different from the method for fabricating Sample 11 in that the silicon particles Si-REF are used instead of the silicon particles Si-Ain First step. Different portions are described in detail below, and the above description is referred to for portions where a method similar to the above was employed.

### [First Step]

Predetermined amounts of materials were weighed and mixed uniformly, whereby a mixture was obtained. Specifically, silicon particles (Si-REF) and polyglutamic acid (PGA) were weighed at a weight ratio Si-REF:PGA=95:5 and mixed. As the polyglutamic acid (PGA), γ-PGA was used.

### <<Operation Characteristics of Comparative Sample 11>>

The operation characteristics of Comparative sample 11 were measured at room temperature (see FIGS. 30 and 31).

The characteristics of the fabricated comparative sample are shown in Table 3.

### Example 2

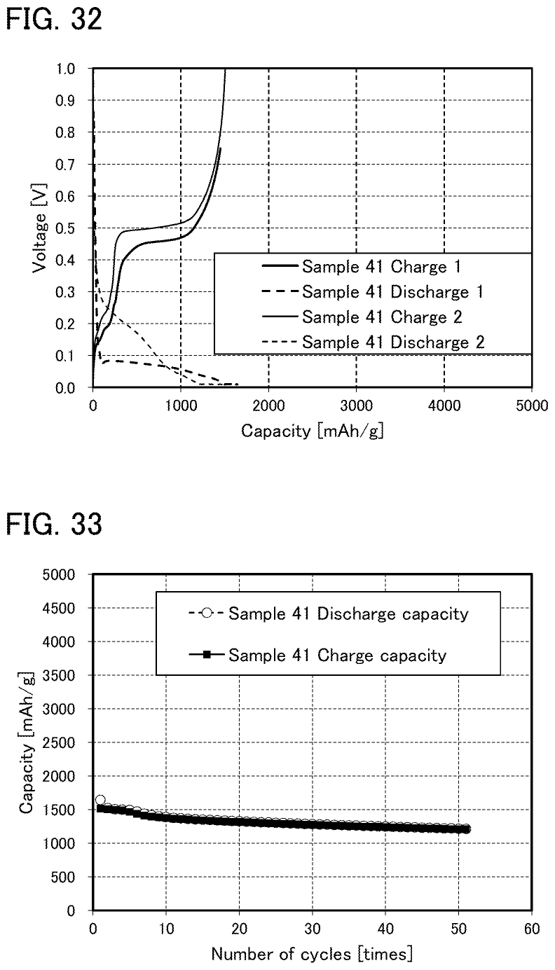

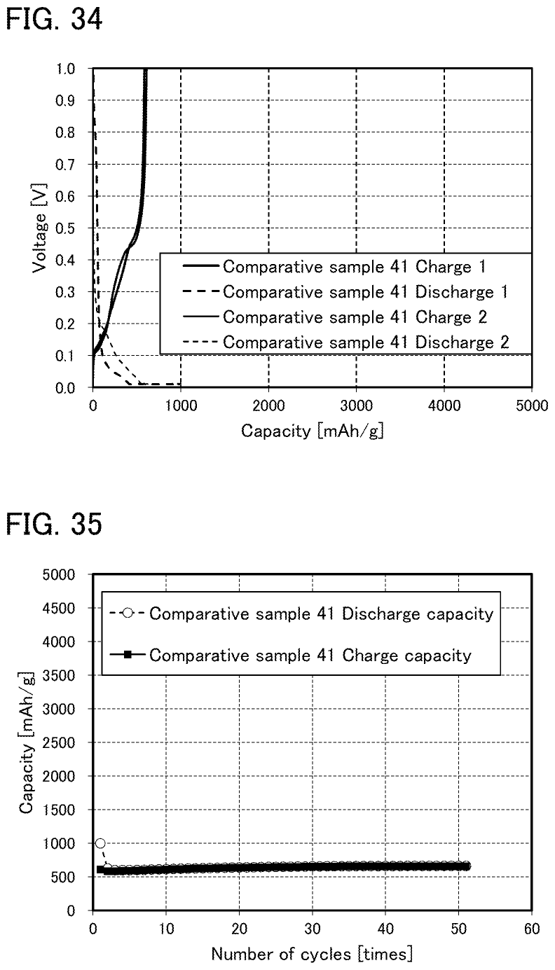

In this example, samples each provided with a negative electrode active material layer that can be used for the secondary battery of one embodiment of the present invention are described with reference to FIG. 32, FIG. 33, FIG. 34, and FIG. 35.

FIG. 32 shows results of a charge-discharge cycle test on Sample 41.

FIG. 33 shows results of the charge-discharge cycle test on Sample 41.

FIG. 34 shows results of a charge-discharge cycle test on Comparative sample 41.

FIG. 35 shows results of the charge-discharge cycle test on Comparative sample 41.

### <Sample 41>

The samples fabricated in this example each have a coin-type half cell structure. Note that a can made of stainless-steel (SUS) was used for each of the positive electrode can and the negative electrode can.

Sample 41 fabricated in this example includes the negative electrode active material layer 102 (see FIG. 11A). The negative electrode active material layer 102 includes the silicon particles 121S, the binder 122, and graphite GP (see FIG. 11C). The weight ratio of the binder 122 to the silicon particles 121S is 10/30. The weight ratio of the graphite GP to the silicon particles 121S is 50/30.

The binder 122 has a carboxy group. Specifically, polyglutamic acid (PGA) was used as the binder 122.

### <<Structure of Sample 41>>

Table 9 shows the structure of Sample 41. Note that a negative electrode active material layer that can be used in the secondary battery of one embodiment of the present invention was used for one electrode, and a lithium metal was used for the other electrode.

TABLE 9

| | Reference | | Weight |
|---|---|---|---|
| Structure | numeral | Material | ratio |
| Current collector | CC2 | Copper foil | |
| Negative electrode | 102 | Si-A:PGA:GP:AB | 30:10:50:10 |
| active material layer | | | |
| Electrolyte solution | 104 | LiFSI:EMI-FSI | |
| Separator | 103 | PP | |
| Electrode | | Li | |

Graphite obtained by coating spherical natural graphite with low crystalline carbon (Formula BT 1520T produced by Superior Graphite) was used as the graphite GP. The average particle diameter of the graphite GP is 20 m.

In addition, acetylene black (AB) was used as a conductive additive.

### <<Method for Fabricating Sample 41>>

Sample 41 described in this example was fabricated by a method including the following steps.

### [First Step]

Predetermined amounts of materials were weighed and mixed uniformly, whereby a mixture was obtained. Specifically, silicon particles (Si-A), polyglutamic acid (PGA), graphite (GP), and acetylene black (AB) were weighed at a weight ratio Si-A:PGA:GP:AB=30:10:50:10 and mixed.

### [Second Step]

Next, a solvent was added to the mixture, and the mixture was mixed uniformly with the use of a planetary centrifugal mixing and defoaming machine to obtain a slurry. Note that deionized water can be used as the solvent.

### [Third Step]

Next, the slurry was applied to the negative electrode current collector CC2 using an applicator, and then drying was performed. Note that a copper foil was used as the negative electrode current collector.

### [Fourth Step]

Subsequently, the coating film was expanded using a calendar roll to form a negative electrode active material layer.

### <<Operation Characteristics of Sample 41>>

The operation characteristics of Sample 41 were measured at room temperature (see FIGS. 32 and 33). Note that 1 C was calculated from the amount of the active material used assuming that the capacity of the negative electrode active material was 1806 mAh/g. The operation characteristics of the sample were examined by the same method as that described in Example 1.

The characteristics of the fabricated samples are shown in Table 3.

Sample 41 was found to exhibit favorable characteristics. For example, the first discharge capacity of Sample 41 was 1908 mAh/g or higher.

Sample 41 exhibited better electrical characteristics and charge-discharge cycle performance than Comparative sample 41 described later.

### Comparative Example 2

Comparative sample 41 described in this example includes a negative electrode active material layer different from that of Sample 41. Specifically, silicon particles Si-REF were used as the silicon particles 121S instead of the silicon particles Si-A. Different portions are described in detail below, and the above description is referred to for portions where a method similar to the above was employed.

### <<Structure of Comparative Sample 41>>

Table 10 shows the structure of Comparative sample 41.

TABLE 10

| | Reference | | Weight |
|---|---|---|---|
| Structure | numeral | Material | ratio |
| Current collector | CC2 | Copper foil | |
| Negative electrode | 102 | Si-REF:PGA:GP:AB | 30:10:50:10 |
| active material layer | | | |
| Electrolyte solution | 104 | LiFSI:EMI-FSI | |
| Separator | 103 | PP | |
| Electrode | | Li | |

### <<Method for Fabricating Comparative Sample 41>>

A method for fabricating Comparative sample 41 is different from the method for fabricating Sample 41 in that the silicon particles Si-REF are used instead of the silicon particles Si-A in First step. Different portions are described in detail below, and the above description is referred to for portions where a method similar to the above was employed.

### [First Step]

Predetermined amounts of materials were weighed and mixed uniformly, whereby a mixture was obtained. Specifically, silicon particles (Si-REF), polyglutamic acid (PGA), graphite (GP), and acetylene black (AB) were weighed at a weight ratio Si-REF:PGA:GP:AB=30:10:50:10 and mixed.

### <<Operation Characteristics of Comparative Sample 41>>

The operation characteristics of Comparative sample 41 were measured at room temperature (see FIGS. 34 and 35).

The characteristics of the fabricated comparative sample are shown in Table 3.

This application is based on Japanese Patent Application Serial No. 2022-104610 filed with Japan Patent Office on Jun. 29, 2022, the entire contents of which are hereby incorporated by reference.

What is claimed is:

1. A secondary battery comprising:
a positive electrode active material layer;
a negative electrode active material layer; and
a separator,
wherein the separator is positioned between the positive electrode active material layer and the negative electrode active material layer,
wherein the negative electrode active material layer comprises a silicon particle and a binder,
wherein a weight ratio of the binder to the silicon particle is greater than or equal to 0.05 and less than or equal to 10,
wherein the binder comprises a carboxy group, and
wherein bulk specific gravity of the silicon particle is greater than or equal to 0.02 g/cm³ and less than or equal to 0.5 g/cm³.

2. The secondary battery according to claim 1, further comprising an electrolyte solution,
wherein the electrolyte solution is included in both of the positive electrode active material layer and the negative electrode active material layer, and
wherein the electrolyte solution comprises an ionic liquid.

3. The secondary battery according to claim 2,
wherein the electrolyte solution comprises lithium bis(fluorosulfonyl)imide and 1-ethyl-3-methylimidazolium bis(fluorosulfonyl)imide.

4. The secondary battery according to claim 1,
wherein the binder comprises polyglutamic acid.

5. The secondary battery according to claim 1,
wherein the binder comprises poly(acrylic acid).

6. The secondary battery according to claim 1,
wherein the negative electrode active material layer comprises graphite, and
wherein a weight ratio of the graphite to the silicon particle is greater than 0 and less than or equal to 19.

7. A secondary battery comprising:
a positive electrode active material layer;
a negative electrode active material layer; and
a separator,
wherein the separator is positioned between the positive electrode active material layer and the negative electrode active material layer,
wherein the negative electrode active material layer comprises graphite, a silicon particle, and a binder,
wherein the binder comprises a carboxy group,
wherein a weight ratio of the binder to the silicon particle is greater than or equal to 0.05 and less than or equal to 10, and
wherein a weight ratio of the graphite to the silicon particle is greater than 0 and less than or equal to 19.

8. The secondary battery according to claim 7, further comprising an electrolyte solution,
wherein the electrolyte solution is included in both of the positive electrode active material layer and the negative electrode active material layer, and
wherein the electrolyte solution comprises an ionic liquid.

9. The secondary battery according to claim 8,
wherein the electrolyte solution comprises lithium bis(fluorosulfonyl)imide and 1-ethyl-3-methylimidazolium bis(fluorosulfonyl)imide.

10. The secondary battery according to claim 7,
wherein the binder comprises polyglutamic acid.

11. The secondary battery according to claim 7,
wherein the binder comprises poly(acrylic acid).
